(19) United States
(12) Patent Application Publication
(10) Pub. No.: US 2007/0003586 A1
(43) Pub. Date: Jan. 4, 2007

(54) Insecticidal coating for use on cellulosic substrates

(76) Inventors: John B. Homoelle JR., Cincinnati, OH (US); Norman S. Seung, Mason, OH (US)

Correspondence Address: DINSMORE & SHOHL LLP;One Dayton Centre, Suite 1300, One South Main Street, Dayton, OH, 45402-2023, US

(21) Appl. No.: 11/173,202

(22) Filed: Jul. 1, 2005

(51) Int. Cl. A01N 65/00; A01N 53/00; A01N 25/00

(52) U.S. Cl. 424/405; 514/65; 514/531

(57) ABSTRACT

An insecticidal coating composition is provided for use on cellulosic substrates such as packaging materials to provide protection against insects. The insecticidal coating includes a polyvinyl acetate emulsion; a vinyl acetate ethylene copolymer emulsion; and an insecticide having an LD50 value of between about 14,500 to 15,500 mg/kg. The coating may also include additives such as fillers, defoaming agents, leveling agents, preservatives, and humectants. The insecticidal coating composition may be applied to a variety of cellulosic substrates including corrugated board, linerboard, paper, paper bags, wooden pallets, and paper composite pallets.

### BACKGROUND OF THE INVENTION

This invention relates to an insecticidal coating for use on cellulosic substrates, and more particularly, to an insecticidal coating, which, when applied to cellulosic substrates used as packaging materials, provides a barrier against insects on the packaging and its contents.

Compositions such as insecticides are commonly used to kill insects and repel them from food or other consumable products. A common method currently used to control insects is to spray an insecticide in areas where food products are stored in packages, such as in a warehouse. However, this method suffers from a number of disadvantages. For example, the insecticides used are toxic to humans and may be harmful to the environment, and they require reapplication at regular intervals as they only eliminate insects present at the time of application. Furthermore, when the insects are killed, they have often already invaded the food packaging, thus, their bodies may remain inside the packaged food.

Attempts have been made to produce insecticides which are less toxic to humans. See, for example, U.S. Pat. No. 5,688,509, which teaches a controlled release insect repellent device which is non-toxic to humans and animals. However, such a device is not effective in eliminating the insects. U.S. Pat. No. 6,436,421 teaches a pesticide composition having low toxicity for application to plants. See also U.S. Pat. No. 4,966,796, which teaches treating kraft paper with an insecticidal composition which is applied to a liner for use in forming a grain storage bag. However, it would be desirable to be able to apply an insecticide directly to a wider variety of food packaging materials, which insecticide is low in toxicity and long-lasting.

Accordingly, there is still a need in the art for an insecticide for use with consumable items which has low toxicity to humans and which maintains its effectiveness in killing insects over time.

### SUMMARY OF THE INVENTION

Embodiments of the present invention meet those needs by providing an insecticidal coating composition for use on cellulosic substrates such as paper packaging which has a low toxicity to humans and which effectively kills insects which come into contact with the coating. The coating maintains its effectiveness over an extended period of time.

According to one aspect of the present invention, an insecticidal coating composition for use on cellulosic substrates is provided comprising a polyvinyl acetate emulsion; a vinyl acetate ethylene copolymer emulsion; and an insecticide having an LD50 value of between about 14,500 to about 15,500 mg/kg. By “LD50” value, it is meant “lethal dose 50%” value, which indicates the quantity of a substance, which, when administered to a population of subjects (typically rats), will cause 50% of the subjects to perish.

Preferably, the insecticide used in the composition is a pyrethroid insecticide, and more preferably, comprises deltamethrin ((S)-cyano-3-phenoxybenzyl(1R)-cis-3-(2,2-dibromovinyl)-2,2-dimethylcyclopropane carboxylate).

The insecticidal coating composition may include a number of other components including inorganic fillers, which are preferably selected from the group consisting of clay, talc, mica, and mixtures thereof. The insecticidal coating composition may further include defoaming agents, leveling agents, preservatives, and humectants, and wax emulsions.

The insecticidal coating composition preferably has a pH of between about 5.8 and 6.7, and more preferably, between about 6.0 and 6.5.

In a preferred embodiment of the invention, the insecticidal coating composition comprises from about 5 to about 30 wt % of a polyvinyl acetate emulsion; from about 5 to about 30 wt % of a vinyl acetate ethylene copolymer emulsion; from about 5 to about 50 wt % of an organic filler; and from about 0.1 to 2.5 wt % an insecticide. The composition may optionally further include from about 0.05 to about 0.50 wt % of a defoaming agent, from about 0.05 to about 1 wt % of a leveling agent, from about 0 to 0.50 wt % of a preservative, from about 1.0 to about 15 wt % of a humectant, and from about 1 to 15 wt % of a wax emulsion comprised of natural or synthetic waxes.

In use, the insecticidal coating composition is applied to at least one surface of a cellulosic substrate having first and second major surfaces, such that at least one of the major surfaces includes the coating thereon. The cellulosic substrate is preferably selected from corrugated board, linerboard, paper, paper bags, wooden pallets, and paper composite pallets. Once applied to the substrate, the coating is preferably dried. The dried coating is preferably from about 1 to about 4 microns thick.

The coating composition of the present invention, when applied to cellulosic materials such as, for example, packaging materials, provides an effective barrier against insect infestation of the packaging materials as well as their contents over an extended period of time.

Accordingly, it is a feature of the present invention to provide an insecticidal coating composition and a method of applying the composition to cellulosic substrates. It is a further feature of the invention to provide an insecticidal coating composition which has a low toxicity to humans, which effectively kills insects coming into contact with the coating, and which maintains its effectiveness over an extended period of time. These, and other features and advantages of the present invention will become apparent from the following detailed description.

### DETAILED DESCRIPTION OF THE PREFERRED EMBODIMENT

The insecticidal coating composition of the present invention provides an effective barrier against insect infestation and has a low toxicity to humans. Further, the composition is non-transferable to human skin by normal handling of packaging because it is bound in a polymer matrix.

The coating composition is based on a polymeric matrix formed from a liquid comprising a blend of a water-borne polyvinyl acetate emulsion and a water-borne vinyl acetate ethylene copolymer emulsion. The composition preferably comprises about 5 to 30% by weight of the polyvinyl acetate emulsion, and about 5 to 30% by weight of the vinyl acetate ethylene copolymer emulsion. The polyvinyl acetate emulsion and vinyl acetate ethylene copolymer emulsion are preferably prepared by a free radical polymerization in which a pre-emulsion of the monomers is made using a water/surfactant blend. Polymerization is initiated through the use of redox agents such as persulfate/metabisulfate salts, or by the generation of free radicals. Such products are manufactured, for example, by Air Products under the designations Vinac® and Airflex®. The composition is preferably formulated such that its pH is naturally buffered between about 6.0 and 6.7.

The insecticide used in the present invention is preferably a pyrethroid insecticide. Preferably the insecticide comprises deltamethrin ((S)-cyano-3-phenoxybenzyl(1R)-cis-3-(2,2-dibromovinyl)-2,2-dimethylcyclopropane carboxylate) in the form of a dispersion containing about 3 to 7% active ingredients. The deltamethrin is preferably incorporated into the blend of polymeric emulsions by processing means known in the art. The insecticide is preferably included in an amount of about 0.1 to 2.5 wt %. The insecticide has an LD50 value of about 15,000 mg/kg. When the insecticide is incorporated into the coating composition, the resulting composition has an LD50 value of about 975,000 mg/kg. Thus, the composition has a very low toxicity to humans.

The insecticidal coating composition of the present invention preferably further contains an inorganic filler, which functions as an extender for the coating. Suitable inorganic fillers include clay, mica, talc, and mixtures thereof. The inorganic filler is preferably included in an amount of from about 5 to 50% by weight of the composition. The composition may further include one or more defoaming agents, leveling agents, preservatives, or humectants. The composition preferably further includes from about 1 to 15 wt % of a wax emulsion comprised of natural or synthetic waxes. Such waxes can be paraffinic in nature, or may comprise microcrystalline waxes, Fischer Tropsch waxes, natural waxes such as carnauba, candelilla and bees wax as well as montan waxes. Alternatively, the waxes may be synthetically derived, such as unoxidized or oxidized low density polyethylene waxes.

The insecticidal coating is applied to a cellulosic substrate in any suitable manner including gravure coating, blade coating, wire rod coating, flexographic printing, lithographic printing, air knife coating, curtain coating, and the like. Where the substrate comprises wood or composite pallets, the coating is preferably applied by spraying or dipping. No pretreatment of the substrate is necessary. The coating composition is preferably applied to at least one side of the substrate such that upon drying, the coating forms a smooth, evenly distributed layer of about 1 to 4 microns in thickness, which imparts the desired protection to the substrate. After the coating is applied, it may be dried under ambient conditions or heated by any suitable means including steam cans, hot plates, forced air, fans, or any other means which provides a clear, adherent coated film.

The packaging materials to which the composition is applied include the outside surfaces of packages containing food or other consumable items as well as non-consumable items. Examples of substrates which may be coated include paper, paper bags, paperboard, corrugated boxes, and pallets. The composition may also be coated onto plastic or plastic sheeting; however, such substrates may require a pretreatment prior to coating such as corona treatment. After coating, the substrates may be printed with conventional water or solvent based printing inks.

Due to the low LD50 value of the coating, it has a very low toxicity to humans. When insects come into contact with the coated substrate, the active ingredient of the insecticide migrates into the membranes on their appendages and affects their metabolism such that they are killed by a breakdown of their cellular system. The coating remains active for about two years, and is effective in killing a wide variety of insects including, but not limited to, silverfish, cockroaches, mites, spiders, weevils, ants, and mosquitoes.

While certain representative embodiments and details have been shown for purposes of illustrating the invention, it will be apparent to those persons skilled in the art that various changes in the compositions, methods, and apparatus disclosed herein may be made without departing from the scope of the invention.

1. An insecticidal coating composition for use on cellulosic substrates comprising:
a) a polyvinyl acetate emulsion;
b) a vinyl acetate ethylene copolymer emulsion; and
c) an insecticide having an LD50 value of between about 14,500 and 15,500 mg/kg.

2. The insecticidal coating composition of claim 1 further including an inorganic filler.

3. The insecticidal coating composition of claim 2 wherein said filler is selected from the group consisting of clay, talc and mica.

4. The insecticidal coating composition of claim 1 further including a defoaming agent.

5. The insecticidal coating composition of claim 1 further including a leveling agent.

6. The insecticidal coating composition of claim 1 further including a preservative.

7. The insecticidal coating composition of claim 1 further including a humectant.

8. The insecticidal coating composition of claim 1 further including a wax emulsion comprising natural or synthetic waxes.

9. The insecticidal coating composition of claim 1 wherein said insecticide is a pyrethroid insecticide.

10. The insecticidal coating composition of claim 9 wherein said insecticide comprises deltamethrin.

11. The insecticidal coating composition of claim 1 having a pH of between about 5.8 and 6.7.

12. The insecticidal coating composition of claim 1 having a pH of between about 6.0 and 6.5.

13. An insecticidal coating composition for use on cellulosic substrates comprising:
from about 5 to about 30 wt % of a polyvinyl acetate emulsion;
from about 5 to about 30 wt % of a vinyl acetate ethylene copolymer emulsion;
from about 5 to about 50 wt % of an organic filler;
from about 1 to 15 wt % of a wax emulsion; and
from about 0.1 to 2.5 wt % an insecticide.

14. The insecticidal coating of claim 13 wherein said filler is selected from the group consisting of clay, talc, mica, and mixtures thereof.

15. The insecticidal coating of claim 13 further including from about 0.05 to about 0.50 wt % of a defoaming agent.

16. The insecticidal coating of claim 13 further including from about 0.05 to about 1 wt % of a leveling agent.

17. The insecticidal coating of claim 13 further including from about 0 to 0.50% of a preservative.

18. The insecticidal coating of claim 13 further including from about 1.0 to about 15 wt % of a humectant.

19. A coated cellulosic substrate having first and second major surfaces, with at least one of said major surfaces having coated thereon an insecticidal coating, said coating comprising an insecticide having an LD50 value of between about 14,500 and 15,500 mg/kg in a blend of polyvinyl acetate and vinyl acetate ethylene.

20. The coated cellulosic substrate of claim 19 wherein said substrate is selected from corrugated board, linerboard, paper, paper bags, wooden pallets, and paper composite pallets.

21. The coated substrate of claim 19 wherein said insecticidal coating is about 1 to about 4 microns thick.

22. A method of applying an insecticidal coating to a cellulosic substrate comprising:
providing a cellulosic substrate having first and second major surfaces; and
applying an insecticidal coating composition to at least one of said major surfaces of said substrate; said insecticidal coating comprising a polyvinyl acetate emulsion; a vinyl acetate-ethylene copolymer emulsion; and an insecticide having an LD50 value of between about 14,500 to 15,500 mg/kg.

23. The method of claim 22 including drying said insecticidal coating after applying said coating to said at least one major surface of said substrate.
